(19) United States
(12) Patent Application Publication
(10) Pub. No.: US 2026/0126516 A1
(43) Pub. Date: May 7, 2026

(54) METHOD FOR OPTIMIZED DETECTION OF AN ENVIRONMENT OF A RADAR SYSTEM

(71) Applicant: Robert Bosch GmbH, Stuttgart (DE)

(72) Inventor: Christian Matthias Didong, Asperg (DE)

(21) Appl. No.: 19/321,701

(22) Filed: Sep. 8, 2025

(30) Foreign Application Priority Data
Nov. 5, 2024 (DE) 10 2024 210 619.4

(51) Int. Cl. G01S 7/02; G01S 7/28; G01S 7/292; G01S 13/931

(52) U.S. Cl. CPC G01S 7/021; G01S 7/2813; G01S 7/2923; G01S 13/931; G01S 2013/93185

(57) ABSTRACT

A method for optimized detection of an environment of a radar system. The steps include: transmitting a radar signal by a transmitting unit of the radar system, wherein an authentication sequence adapted to channel properties of a physical transmission channel is embedded into the transmitted radar signal; receiving a radar signal by a receiving unit of the radar system via the physical transmission channel, and accepting the radar signal received by the receiving unit of the radar system as valid if an authentication sequence contained in the received radar signal has a sufficient similarity to the adapted authentication sequence embedded in the transmitted radar signal.

### CROSS REFERENCE

The present application claims the benefit under 35 U.S.C. § 119 of Germany Patent Application No. DE 10 2024 210 619.4 filed on Nov. 5, 2024, which is expressly incorporated herein by reference in its entirety.

### FIELD

The present invention relates to a method for channel-optimized detection of an environment of a radar system and to an authentication unit for a radar system for protection against attacks by third parties on the radar system by using an authentication sequence adapted to channel properties of a transmission channel.

### BACKGROUND INFORMATION

Radar technology is used in various areas for detecting objects in the environment by means of radio waves. The focus is on recognizing and locating objects. Depending on the radar technology and signal processing used, the distance, angle and speed of an object in the environment of the radar system can be determined.

Germany Patent Application No. DE 10 2014 017 671 A1 relates to a conventional method for authenticating data packets in an open network, via which a sender and a receiver are connected to one another. The sender has a number of predefined permissible authentication numbers, wherein the sender marks a data packet by adding a permissible authentication number to the data packet. This number subsequently becomes impermissible for the sender. The sender sends the marked data packet over the network. The receiver receives the marked data packet and checks the received data packet for the presence of a permissible authentication number. The receiver discards the received data packet if a permissible authentication number is not identified in the received data packet. Conversely, the receiver accepts the received data packet for further processing if a permissible authentication number is identified in the received data packet. This number subsequently becomes impermissible for the receiver.

Radar systems are generally based on the principle that a reflection of a radar signal transmitted by the radar system is received again by the radar system and, based on characteristics of the received radar signal, information regarding the environment of the radar system can be extracted. There are various radar technologies such as a frequency-modulated carrier wave (FMCW) radar system. In addition, there are radar variants such as digital radar systems (digital radar), in which a message packet of a certain form is transmitted and the reception of the same message packet is subsequently recognized. Due to interference and noise, the received signal is then usually correlated with the transmitted message packet in order to establish a defined tolerance against transmission errors.

The measured radar signals are not authenticated in conventional radar systems and can therefore be falsified by an attacker. An attacker can therefore transmit an identical signal, which is mistakenly recognized by the radar system as a reflection of its own signal and thus lead to an incorrect result regarding the environment of the radar system. For example, an object could be mistakenly recognized at a much shorter distance to the radar system or at a different speed relative to the radar system than is actually the case. Depending on the resolution of the radar image, if the object is classified based on radar data, the classification of the object can also be distorted so that, for example, a pedestrian in the environment is mistakenly recognized as a car.

### SUMMARY

According to a first aspect, the present invention provides a method for optimized detection of an environment of a radar system. According to an example embodiment of the present invention, the method includes the steps of:
transmitting a radar signal by a transmitting unit of the radar system, wherein an authentication sequence adapted to channel properties of a physical transmission channel is embedded into the transmitted radar signal;
receiving a radar signal by a receiving unit of the radar system via the physical transmission channel; and
accepting the radar signal received by the receiving unit of the radar system as valid if an authentication sequence contained in the received radar signal has a sufficient similarity to the adapted authentication sequence embedded in the transmitted radar signal.

A core feature of the present invention is the extension of an existing radar system in such a way that authentication sequences are built into or embedded into the radar signals, in particular in radar data packets or frames, and that, upon reception of the reflected radar signals, in particular radar data packets, the authentication sequences contained therein are compared with the temporarily stored expected authentication sequences in order to distinguish valid from invalid radar data packets.

The method according to the present invention thereby prevents possible attacks on road users who use radar systems, in particular spoofing attacks and jamming attacks.

A significant advantage of the method according to the present invention is that it can take into account channel properties of a physical transmission channel for transmitting radar signals and that it can use authentication sequences that can be adapted to these channel properties. The channel properties of the transmission channel can be specified or known or can be ascertained by means of a measurement signal.

The method according to the present invention also leads to a more reliable classification of objects in the environment of the radar system.

The method according to the present invention preferably comprises a computer-implemented method for detecting an environment of a radar system. The calculation steps of the various algorithms executed by a calculation unit are executed at high data processing speed, preferably in real time.

Authentication sequences are already used in conventional protocols to authenticate messages sent from one party to another party. However, one difference from the method according to the present invention is that, traditionally, two different parties with two different identities communicate with one another. Furthermore, the main function is data exchange by means of authenticated message packets and not radar-based environmental detection. The method according to the present invention serves to secure data for environmental detection. The data are sent and received by the same identity so that there is no data exchange with other identities.

As a result, in contrast to a conventional approach, the method according to the present invention is intended not to secure communication between two parties, but rather, so to speak, communication of a single party or identity with itself, thereby simplifying the requirements for message security. In the method according to the present invention, elaborate key management can be dispensed with, and prior synchronization of a plurality of parties can likewise be omitted. Instead, in the method according to the present invention, one participating party or the radar system can, for example, simply instantiate the authentication sequence as a random sequence or, if a cryptographic key approach is considered advantageous, the radar system, as the only participating party, can easily generate this cryptographic key locally and does not have to synchronize it with other parties or devices.

In one possible embodiment of the method according to the present invention for detecting an environment of a radar system, the authentication sequence is generated on the basis of a provided random sequence.

In one possible embodiment of the method according to the present invention for detecting an environment of a radar system, the random sequence comprises a random number sequence that is generated by a random number generator of the radar system. This allows for simple and reliable implementation.

In a possible alternative embodiment of the method according to the present invention for detecting an environment of a radar system, the random sequence is generated by an encryption unit of the radar system according to an encryption function. This allows the use of existing encryption units.

In one possible embodiment of the method according to the present invention for detecting an environment of a radar system, the random sequence is modified by means of a first algorithm according to a first specified function for generating a modified random sequence. As a result, an adaptation to the properties of the radar signal transmission path can be carried out.

In one possible embodiment of the method according to the present invention for detecting an environment of a radar system, the generated random sequence is modified, for generating the modified random sequence, by interleaving the random sequence with further provided bits, which adapt the signal properties of the authentication sequence that is embedded into the radar signal transmitted by the transmitting unit, in such a way that the authentication sequence contained within the radar signal received by the receiving unit via the physical transmission channel is more clearly recognizable.

In one possible embodiment of the method according to the present invention for detecting an environment of a radar system, the provided bits with which the random sequence is interleaved comprise a firmly specified sequence of bits or are selected according to bit sequences within the random sequence.

In one possible embodiment of the method according to the present invention for detecting an environment of a radar system, the random sequence comprises a random bit sequence, which is divided into a plurality of groups of random bits, wherein provided bits are inserted between two consecutive groups of random bits in each case, which provided bits adapt the signal properties of the authentication sequence that is embedded into the radar signal transmitted by the transmitting unit, in such a way that the authentication sequence contained within the radar signal received by the receiving unit of the radar system via the physical transmission channel is more clearly recognizable.

In one possible embodiment of the method according to the present invention for detecting an environment of a radar system, the groups of random bits within the random bit sequence of the random sequence in each case comprise a certain number of random bits.

In one possible embodiment of the method according to the present invention for detecting an environment of a radar system, the bits inserted between two consecutive groups of random bits of the random bit sequence of the random sequence comprise at least one code bit sequence of a code set comprising different code bit sequences, which are selected according to the preceding and/or according to the subsequent group of random bits of the random sequence.

In one possible embodiment of the method according to the present invention for detecting an environment of a radar system, the random bits of the preceding group of random bits and the random bits of the subsequent group of random bits in each case form an index, which is used for selecting the inserted code bit sequence.

In one possible embodiment of the method according to the present invention for detecting an environment of a radar system, a radar data packet is calculated by means of a second algorithm according to a second specified function on the basis of the modified random sequence.

In one possible embodiment of the method according to the present invention for detecting an environment of a radar system, the calculated radar data packet is transmitted by the transmitting unit of the radar system and temporarily stored as an internal radar data packet in a buffer unit of the radar system. This makes possible a reliable and robust comparison between transmitted radar data packets and received radar data packets.

In one possible embodiment of the method according to the present invention for detecting an environment of a radar system, a radar data packet received by the receiving unit of the radar system is compared by means of a third algorithm with the internal radar data packet temporarily stored in the buffer unit, in order to determine whether an authentication sequence contained in the received radar data packet has a sufficient similarity to an authentication sequence contained in the temporarily stored internal radar data packet. The required sufficient similarity can be flexibly set in the third algorithm according to the application case of the radar system and a desired security level.

In one possible embodiment of the method according to the present invention for detecting an environment of a radar system, the radar data packet received by the receiving unit of the radar system is accepted as valid if the authentication sequence contained in the received radar data packet has a sufficient similarity to the authentication sequence contained in the temporarily stored internal radar data packet.

According to a further aspect, the present invention further provides an authentication unit for a radar system that is designed to accept a radar signal received by a receiving unit of the radar system via a physical transmission channel as valid if an authentication sequence contained in the received radar signal has a sufficient similarity to an authentication sequence that is embedded in a radar signal transmitted by a transmitting unit of the radar system and that is adapted to channel properties of the physical transmission channel.

In one possible embodiment of the authentication unit according to the present invention for a radar system, the authentication unit comprises a random number generator that is designed to generate a random number sequence as a random sequence.

In a further possible embodiment of the authentication unit according to the present invention, the authentication unit of the radar system comprises an encryption unit that is designed to generate a random sequence according to an encryption function, wherein the authentication sequence embedded in the transmitted radar signal is generated on the basis of the generated random sequence.

In a further possible embodiment of the authentication unit according to the present invention, the generated random sequence is modified, for generating a modified random sequence, by interleaving the random sequence with further provided bits, which adapts the signal properties of the authentication sequence that is embedded into the radar signal transmitted by the transmitting unit, in such a way that the authentication sequence contained within the radar signal received by the receiving unit via the physical transmission channel is more clearly recognizable.

In one possible embodiment of the authentication unit according to the present invention for a radar system, the authentication unit contains a calculation unit that is designed to modify the generated random sequence by means of a first algorithm according to a first specified function for generating a modified random sequence, to calculate a radar data packet by means of a second algorithm according to a second specified function on the basis of the modified random sequence, wherein the calculated radar data packet is transmitted by the transmission unit of the radar system and is temporarily stored as an internal radar data packet in a buffer unit of the authentication unit.

In one possible embodiment of the authentication unit according to the present invention for a radar system, the calculation unit is further designed to compare, by means of a third algorithm, a radar data packet received by the receiving unit of the radar system with the temporarily stored internal radar data packet in order to determine whether an authentication sequence contained in the received radar data packet has a sufficient similarity to an authentication sequence contained in the temporarily stored internal radar data packet.

The use of the various programmable algorithms offers a high degree of flexibility and facilitates adaptation of the authentication unit according to the present invention for different application cases.

According to a further aspect, the present invention further provides a radar system. According to an example embodiment of the present invention, the radar system comprises:
a transmitting unit for transmitting a radar signal, wherein an authentication sequence is embedded in the transmitted radar signal, wherein the embedded authentication sequence is adapted to channel properties of a physical transmission channel; a receiving unit for receiving a radar signal via a physical transmission channel; and
an authentication unit that is designed to accept a radar signal received by the receiving unit of the radar system via the physical transmission channel as valid if an authentication sequence contained in the received radar signal has a sufficient similarity to an authentication sequence that is embedded in a radar signal transmitted by the transmitting unit of the radar system and that is adapted to channel properties of the physical transmission channel.

In one possible embodiment of the radar system according to the present invention, the received radar signal accepted as valid is further processed by a signal processing unit of the radar system for detecting an environment of the radar system.

In one possible embodiment of the radar system according to the present invention, the radar system comprises a monostatic or a bistatic radar system.

A bistatic radar system is a radar system in which the transmitting unit and the receiving unit are located at separate locations. In contrast, a radar system in which the transmitting unit and the receiving unit are located at the same location or even use the same antenna is referred to as a monostatic radar system. Radar devices that use separate transmitting and receiving antennas but are mounted closely next to or above one another are likewise considered monostatic radar devices.

The above embodiments and developments may be combined with one another in any reasonable manner. Further possible embodiments, developments, and implementations of the present invention also include combinations not explicitly mentioned of features of the present invention described above or in the following relating to the exemplary embodiments. A person skilled in the art will in particular also add individual aspects as improvements or additions to the relevant basic form of the present invention.

Furthermore, possible embodiments of the method and radar system according to the present invention are described in more detail with reference to the figures.

### BRIEF DESCRIPTION OF THE DRAWINGS

FIG. 1 is a flow chart representing a possible embodiment of the method according to the present invention.

FIG. 2 is a block diagram schematically representing a possible embodiment of a radar system according to the present invention.

FIG. 3 is a schematic representation for explaining the functioning of a radar system according to the present invention.

FIG. 4 is a block diagram representing a further possible embodiment of a radar system according to the present invention.

FIG. 5 is a possible attack scenario for a radar system.

FIG. 6A, 6B are further possible attack scenarios for a radar system.

### DETAILED DESCRIPTION OF EXAMPLE EMBODIMENTS

The figures are intended to impart further understanding of the example embodiments of the present invention. They illustrate embodiments and, in connection with the description, serve to explain principles and concepts of the present invention. Other embodiments and many of the mentioned advantages are apparent from the figures. The elements of the figures are not necessarily shown to scale relative to one another.

In the figures, identical, functionally identical, and identically acting elements, features, and components are designated in each case by the same reference signs, unless otherwise stated.

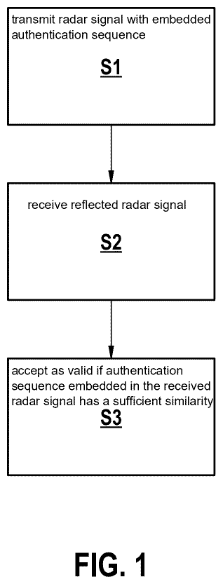

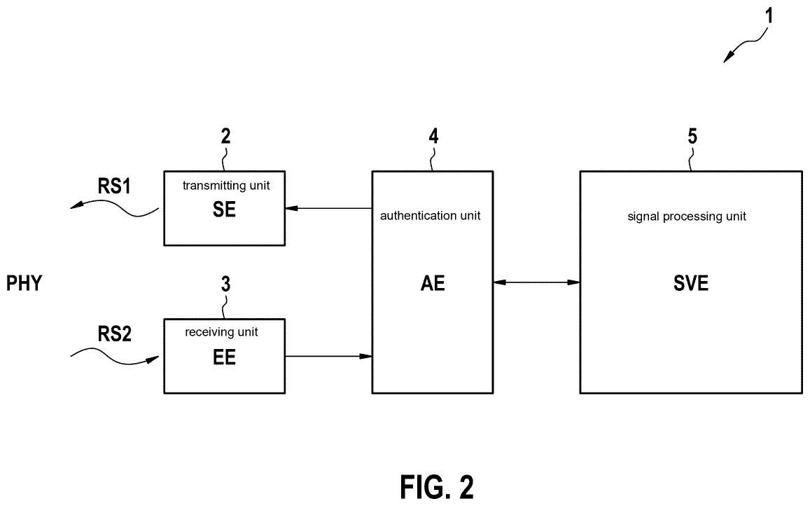

According to a first aspect, the present invention provides a method for optimized detection of an environment of a radar system 1. A possible embodiment of the radar system 1 is shown schematically in FIG. 2. In one possible embodiment, the method substantially comprises a plurality of main steps, as shown in the schematic flow diagram according to FIG. 1.

In a first step S1, a radar signal RS1 is transmitted by a transmitting unit 2 of the radar system 1, wherein an authentication sequence AS1 is embedded into the transmitted radar signal RS1. An authentication sequence AS1 adapted to channel properties of a physical transmission channel PHY is embedded into the transmitted radar signal RS1. In many cases, the channel properties of the transmission channel are known and sufficiently constant. In some application cases, the channel properties of the physical transmission channel PHY can change depending on the environment. For this reason, in a possible implementation of the method, the current channel properties of the transmission channel PHY are measured periodically or in response to an event, for example by means of a transmitted measurement signal.

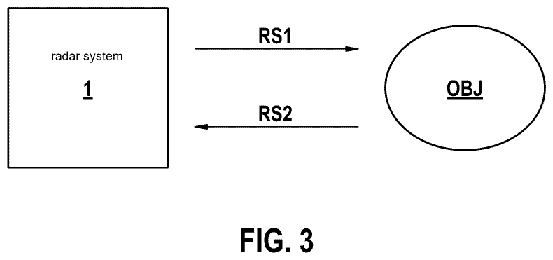

In a further step S2, a radar signal RS2 reflected by an object OBJ is received by a receiving unit 2 of the radar system 1, as shown schematically in FIG. 3.

In a further step S3, the radar signal RS2 received by the receiving unit 3 is accepted as valid if an authentication sequence AS2 contained in the received radar signal RS2 has a sufficient similarity to the authentication sequence AS1 embedded in the transmitted radar signal RS1 and adapted to the channel properties of the transmission channel PHY.

In the method according to the present invention, RDP authentication sequences AS are built into or embedded into the transmitted radar signals RS1, in particular in radar data packets or frames. When receiving the radar signals RS2, in particular the radar data packets RDP, the authentication sequences contained therein are compared with the expected authentication sequences in order to distinguish valid from invalid radar signals or valid from invalid radar data packets.

In one possible embodiment of the method according to the present invention for detecting an environment of a radar system 1, the authentication sequence AS is generated on the basis of a provided random sequence ZS. In one possible embodiment of the method according to the present invention for detecting an environment of a radar system, the random sequence ZS comprises a random number sequence that is generated by a random number generator RNG of the radar system 1 (RNG=random number generator). This random number generator can also be a pseudorandom number generator PRNG. Alternatively, another approach can be used for generating an authentication sequence AS. A random number generator RNG or pseudorandom number generator PRNG is one possible instantiation, but there are also other possibilities of implementing a unit for generating a random sequence ZS. A pseudorandom number generator PRNG can, for example, be implemented with the aid of an encryption function having suitable bit sequences as input. Depending on the calculation algorithm used, the generated output sequence can be sufficiently close to a pseudorandom sequence. In one embodiment of the method according to the present invention for detecting an environment of a radar system 1, the random sequence ZS is generated by an encryption unit of the radar system 1 according to an encryption function.

In one possible embodiment of the method according to the present invention for detecting an environment of a radar system 1, the generated random sequence ZS is modified by means of a first algorithm according to a first specified function (f) for generating a modified random sequence ZSM.

In one possible embodiment of the method according to the present invention for detecting an environment of a radar system 1, the generated random sequence ZS is modified, for generating the modified random sequence ZSM, by interleaving or nesting the random sequence ZS with further provided bits, which adapt the signal properties of the authentication sequence AS1 that is embedded into the radar signal RS1 transmitted by the transmitting unit 2, in such a way that the authentication sequence AS2, which is contained within the radar signal RS2 received by the receiving unit 3 via the physical transmission channel PHY, is clearly or more clearly recognizable.

In one possible embodiment of the method according to the present invention for detecting an environment of a radar system 1, the provided bits with which the random sequence ZS is interleaved or nested comprise a firmly specified sequence of bits or are selected according to bit sequences within the random sequence ZS.

In one possible embodiment of the method according to the present invention for channel-optimized detection of an environment of a radar system 1, the random sequence ZS comprises a random bit sequence, which is divided into a plurality of groups of random bits. Provided bits are inserted between two consecutive groups of random bits in each case, which provided bits adapt the signal properties of the authentication sequence AS1, which is embedded into the radar signal RS1 transmitted by the transmitting unit 2, in such a way that the authentication sequence AS2, which is contained within the radar signal RS2 received by the receiving unit 3 of the radar system 1 via the physical transmission channel, is more clearly recognizable. In one possible embodiment of the method according to the present invention for detecting an environment of a radar system 1, the groups of random bits within the random bit sequence of the random sequence ZS in each case comprise a certain number of random bits.

In one possible embodiment of the method according to the present invention for detecting an environment of a radar system 1, the bits inserted between two consecutive groups of random bits of the random bit sequence of the random sequence ZS comprise at least one code bit sequence or codes C of a code set CS comprising different code bit sequences or codes C, which are selected according to the preceding and/or according to the subsequent group of random bits of the random sequence ZS.

In one possible embodiment of the method according to the present invention for detecting an environment of a radar system 1, the random bits of the preceding group of random bits and the random bits of the subsequent group of random bits in each case form an index, which is used for selecting the inserted code bit sequence C.

There are various possibilities for embedding authentication sequences AS in radar data packets RDP.

A first possibility for embedding authentication sequences AS into radar data packets RDP is that the authentication bits of the authentication sequence AS are modulated and used directly as part of the radar data packet RDP and checked when perceiving the received radar data packet RDP.

A second possibility for embedding authentication sequences AS into radar data packets RDP is to use the authentication bits from the authentication sequence AS in order to pseudorandomly select certain codes C or sequences that are advantageous for recognition.

First, the first possibility, in which authentication bits are embedded into the radar data packet RDP, is described.

For the instantiation of the first algorithm or its function f, the following algorithm or function is used in a possible embodiment of the method according to the present invention.

Here, the authentication sequence AS is interleaved or nested with other bits in order to ensure that the entire sequence has better signal properties when it is modulated onto the physical channel PHY. In particular, the non-random bits can be selected in such a way that the autocorrelation properties of the signal or other properties are improved in order to, e.g., make recognition less ambiguous.

In the method according to the present invention, there are no random attempts to improve the signal quality; rather, either fixed sequences are used that always, or in most cases, result in improved recognition performance, or the bits are selected according to the authentication bits.

In the following, such an interleaving of authentication bits and code bits is described based on a simple exemplary embodiment.

With an exemplary split of 50% authentication bits and 50% code bits for improving detection, the following logic generates an authentication sequence AS used in one possible embodiment.

Here, length (ZS)=|ZS|=n=4*m bits.

1. Generate a bit sequence ZSM of length (ZSM)=2*n bits.

2. For i in [0, 4, 8, . . . , n−4]
a. ZSM [2*i, 2*i+1, 2*i+2, 2*i+3]=ZS [i, i+1, i+2, i+3]
b. Determine the code C for ZS [i, i+1, i+2, i+3] (see below) b.
c. ZSM [2*i+4, 2*i+5, 2*i+6, 2*i+7]=C[i, i+1, i+2, i+3]

The new resulting ZSM is therefore:

$$ZSM = [ ZS [ 0 , 3 ] ‖ Code ‖ ZS [ 4 , 7 ] ‖ Code ‖ ZS [ 8 , 11 ] ‖ … ]$$

$$ZSM = ZS [ 0 ] ZS [ 1 ] ZS [ 2 ] ZS [ 3 ] C [ 0 ] C [ 1 ] C [ 2 ] C [ 3 ] ZS [ 4 ] ZS [ 5 ] ZS [ 6 ] ZS [ 7 ] C [ 4 ] C [ 5 ] C [ 6 ] C [ 7 ] …$$

The notation ZSM [a, b], ZS [a, b], etc. means that these are the bits that start at index a and go up to and include index b. ZSM [a], ZS [a] etc. means that this is the value at index a of the sequence.

The algorithm presented above should be considered as an example. In other embodiments of the method according to the present invention, other interleavings of authentication bits and code bits are carried out. Alternatively, a reduced or increased number of random bits can be used with respect to fixed symbols. The algorithm indicated above is an example for a 50/50 split and for 4 bits of each type in a row. The placement of the bits can also vary. There could be, e.g., 8 random bits, followed by 8 bits for improving the recognition properties, etc.

For the determination of the code C, there are a plurality of possibilities to determine the code C to be embedded.

In a possible first embodiment of the method according to the present invention, this code can be a fixed code that remains the same regardless of the content of the random bits in order to improve the recognition properties of the resulting signal.

Exemplary embodiments for this first embodiment of the method according to the present invention comprise:

### 1st Exemplary Embodiment

Maximum length sequences MLS can be embedded as fixed sequences in the above code sequences for improving the correlation properties.

### 2nd Exemplary Embodiment

Barker codes can be embedded as fixed sequences in order to improve the correlation properties with the above code sequence parts.

### 3rd Exemplary Embodiment

Gold codes can likewise be embedded into the code sequence parts.

### 4th Exemplary Embodiment

Zadoff-Chu sequences can likewise be embedded into the code sequence parts in order to exploit their advantageous properties.

### 5th Exemplary Embodiment

Other CAZAC sequences can also be used.

The length of the gaps is adapted if applicable, depending on which code C or which parts of code C are to be inserted into the parts of the sequence for improving correlation.

In a further possible second embodiment of the method according to the present invention, the code can be a code C, which is calculated dynamically according to the preceding random bits and possibly additionally according to the subsequent random bits.

The advantage of this second embodiment is that it makes adaptation of the code sequence possible according to the random bits selected.

Exemplary embodiments of this second embodiment of the method according to the present invention comprise:

### 1st Exemplary Embodiment

For short intervals of sequences, a local decision can be made on the basis of an offline-prepared decision matrix that selects the values such that local cross-correlation is minimized. Such a technique does not minimize cross-correlation globally, but due to local optimization, it can greatly improve the situation on average compared to completely random sequences. If one considers, e.g., the above example of 4-bit intervals, the preceding and subsequent authentication bits ZS [b−1, b] and ZS [b+1, b+2] can be taken into account for a code block C [a, b].

In this case, since the system stores an optimal code for each bit combination in advance, it would have to buffer 2\hat{ }4=16 codes from which it can select the locally optimal one.

### 2nd Exemplary Embodiment

For longer intervals, a prepared selection of promising codes C can be stored, and if there are a few passages with random and correlation-optimizing bit sequences, the optimal selection could be tried globally for all correlation-optimizing bit sequences simultaneously or locally for each correlation-optimizing bit sequence iteratively one after the other. The optimal selection of tried codes for the current authentication bits can then be used.

### 3rd Exemplary Embodiment

An algorithm can be used that, e.g., optimizes the autocorrelation with the next block to be selected on the basis of all previous bits. In addition, algorithms can also be used to find bit sequences with low cross-correlation. These can also be applied to parts of the sequence.

The presented approach is advantageous in terms of security compared to simply randomly selecting one of the codes, using it as the authentication sequence AS and omitting the selection of random parts, although the random parts degrade the recognition performance compared to fixed optimized sequences. The reason for this is that there are often not enough optimal sequences available in order to achieve our security goals for the analyzed codes. The probability that an attacker successfully falsifies a signal must be very low in order to ensure secure operation of the radar system 1. However, in an efficient radar or ICAS system, the radar frame or radar data packet RDP for recognition cannot be made arbitrarily large; rather, in many application cases, a radar frame of a fixed length must be used. One is therefore restricted to a limited number of such optimal or near-optimal sequences. However, the number of such sequences usually proves to be insufficient from a security perspective. If an attacker has a probability of success of, e.g., 1 in 100 attempts or better, with short sampling cycles, there is a good chance of the attacker succeeding a few times, which can already have serious consequences.

On the other hand, the method according to the present invention can reduce the probability of success of an attack by orders of magnitude and can be designed in such a way that a balance is maintained between security and performance. Depending on the design and length of the authentication sequence AS, the method according to the present invention can achieve a probability of success for a spoofing attack of less than 1 in 1,000,000 attack attempts.

As mentioned above, a second possibility for embedding authentication sequences AS into radar data packets RDP is to use the authentication bits from the authentication sequence AS to pseudorandomly select certain codes C or sequences that are advantageous for recognition.

The authentication sequence AS can be used for protecting radar data packets RDP from attacks by selecting codes C in an unpredictable way, instead of embedding these bits directly. As examples of codes, the ones mentioned above remain valid.

In this case, the corresponding pseudorandom or randomly selected codes are thus modulated on the transmission channel used, rather than directly modulating the bits from the authentication sequence.

When considering a code set (CS) of codes C to be selected for a radar data packet RDP of size N, a number can be assigned to these codes C in order to identify the particular code C, so that the codes C in the set are numbered from 0 to N−1. This means that by specifying a number between 0 and N−1, the corresponding code C can be selected. The current part of the authentication sequence AS can be used in order to generate one or more pseudorandom numbers in the range of 0 to N−1. These numbers are then used to randomly select one of the codes C in the code set CS.

If there is no x for which 2\hat{ }x=N, the processing for the code selection must take this into account in order to still select a code C uniformly at random. For example, after the bits have been taken from the authentication sequence AS that cover a range up to 2\hat{ }y>N, the current part of the authentication sequence can be skipped and the subsequent part taken until the number is a valid index for the code set CS. Alternatively, the number of codes C in the code set CS can be reduced to a power of 2 or another preprocessing algorithm can be used for generating a correct index range.

Next, the index provided by the authentication sequence AS can be used. In the simplest case, a sufficiently large set of codes C is available in the code set CS. In this case, a pseudorandom number is taken from the next part of the random sequence ZS and, based thereon, the code C is selected from the code set CS as the next input for the radar data packet RDP. The random sequence ZS [a, b] is, e.g., selected and the index, which is equal to ZS [a, b], is converted into an integer c. The code C with index c is selected from the code set CS. CS [c], i.e., the code C with this index c, is then embedded into the next radar data packet RDP. If, e.g., ZS [a, b] is 0010, this can be read as the number 2 in binary encoding, and CS [2] can be selected, which can, for example, be a code C with the bit sequence “11101”.

As mentioned above, the number of codes C with good or nearly ideal cross-correlation properties is limited. If the code set CS is not sufficiently large, this can be compensated for by selecting a plurality of codes C from the code set CS and concatenating these selected codes C together.

In contrast to a single code selection, a plurality of intervals from the authentication sequence AS, i.e., ZS [a, b], . . . , ZS [c, d], are now used and the corresponding code C1, . . . , Cm is selected for each of the resulting indices. The concatenation C1 ∥ . . . ∥ Cm of these codes C is then embedded into the radar data packet RDP.

In order to achieve an appropriate level of security, in the case of each of the code selection schemes used, it must be difficult enough for an attacker to guess the correct code C or code sequence, or in the case of correlation, an output that is sufficiently close to it. Therefore, the selection of a single code C for a radar data packet RDP with a fixed length is only possible if the code set CS of the codes C to be selected is large enough for its length.

Starting from the output of function f, the function g must subsequently construct the radar data packet RDP itself.

If the radar system 1 is a digital radar system that uses OFDM, the authentication sequence AS described above can be embedded like other user data at one or more locations of the radar data packet RDP. That is to say, the existing packet structure can be reused. Of course, a separate field or an additional, smaller packet can also be inserted.

If the radar system 1 is pulse-based, the following packet structure can be used for the radar data packet RDP:
SYNC∥SED∥AS

In this example, the authentication sequence AS can be preceded by a synchronization field and a separator SFD for synchronization purposes, and the authentication sequence AS is then embedded. The resulting bit string is then modulated onto the pulse shapes of the underlying PHY layer.

For a pulse-based radar system 1 that can practically embed this sequence, the pulse rate must be sufficiently high to make sufficiently reliable authentication from a security perspective possible while not excessively delaying the radar output. For example, this requirement is met in the case of ultra-wide-band high-rate pulse repetition frequency (UWB HRP).

In one possible embodiment of the method according to the present invention for detecting an environment of a radar system 1, a radar data packet RDP is calculated by means of a second algorithm according to a second specified function (g) on the basis of the modified random sequence ZSM. In one possible embodiment of the method according to the present invention for detecting an environment of a radar system 1, the calculated radar data packet RDP is transmitted by the transmitting unit 2 of the radar system 1 and temporarily stored as an internal radar data packet RDPᵢₙₜₑᵣₙₐₗ in a buffer unit of the radar system 1.

In one possible embodiment of the method according to the present invention for detecting an environment of a radar system 1, a radar data packet RDP received by the receiving unit 3 of the radar system 1 is compared by means of a third algorithm (h) with the internal radar data packet RDPᵢₙₜₑᵣₙₐₗ temporarily stored in the buffer unit, in order to determine whether an authentication sequence AS2 contained in the received radar data packet RDP has a sufficient similarity to an authentication sequence AS1 contained in the temporarily stored internal radar data packet RDPᵢₙₜₑᵣₙₐₗ. The radar data packet RDP_{receive} received by the receiving unit 3 of the radar system 1 is accepted as valid if the authentication sequence AS2 contained in the received radar data packet RDP_{receive} has a sufficient similarity to the authentication sequence AS1 contained in the temporarily stored internal radar data packet RDPᵢₙₜₑᵣₙₐₗ.

The first algorithm f is an algorithm that receives the random sequence ZS as at least one of its inputs and delivers the corresponding value ZSM as output. The instantiation of the algorithm f depends on the radar technology used.

The second algorithm g is an algorithm that receives ZSM as at least one of its inputs and outputs the corresponding radar data packet RDP. g can also be referred to as a function. The radar data packet RDP is transmitted for environmental detection.

The third algorithm h is an algorithm that receives a received radar data packet (RDP_{receive}) and an internally temporarily stored radar data packet (RDP_internal) as at least two of its inputs.

The third algorithm h compares these two radar data packets with one another, in particular the authentication sequences contained therein, and delivers an output of the authentication unit 4 that indicates or characterizes the similarity of the two authentication sequences. This similarity allows the application or the authentication unit 4 to decide whether the match is good enough in order to securely accept the received radar signal or the received radar data packet RDP (frame). The algorithm used is application-specific and depends on the respective radar system 1. For example, this can be achieved by calculating the correlation in the form of the channel impulse response (CIRs) over the corresponding parts of the message. In the case of an ICAS radar system, this check can be combined with the authentication of the data potentially contained.

According to a further aspect, the present invention further provides an authentication unit 4 for a radar system 1 that is designed to accept a radar signal RS2 received by a receiving unit 3 of the radar system 1 as valid if an authentication sequence AS2 contained in the received radar signal RS2 has a sufficient similarity to an authentication sequence AS1 embedded in a radar signal RS1 transmitted by a transmitting unit 2 of the radar system 1.

In one possible embodiment of the authentication unit 4 according to the present invention for a radar system 1, the authentication unit 4 comprises a random number generator RNG that is designed to generate a random number sequence as a random sequence ZS. The authentication sequence AS1 embedded in the transmitted radar signal RS1 is generated on the basis of the generated random sequence ZS.

In a further possible embodiment of the authentication unit 4 according to the present invention, the authentication unit 4 comprises an encryption unit that is designed to generate a random sequence ZS according to an encryption function, wherein the authentication sequence AS1 embedded in the transmitted radar signal RS1 is generated on the basis of the generated random sequence ZS.

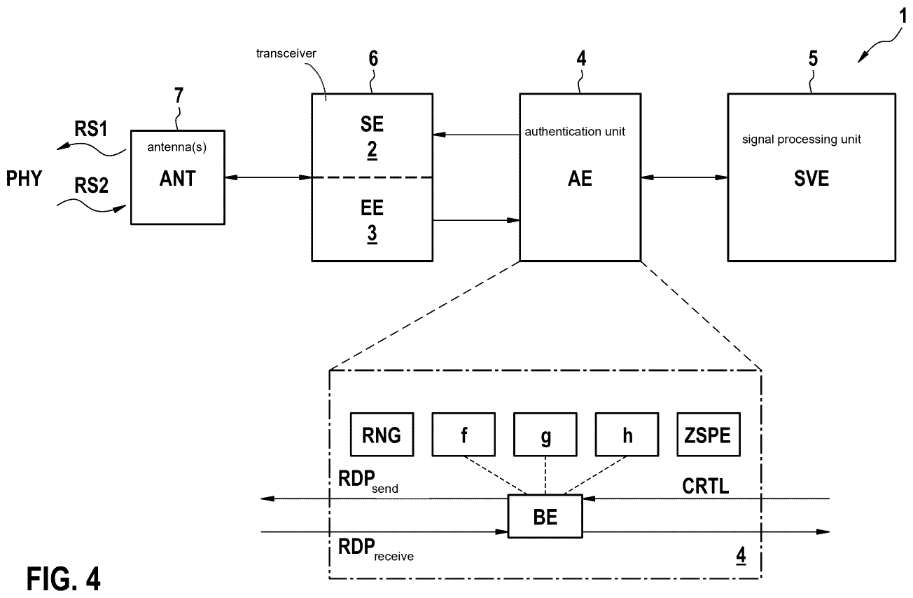

In one possible embodiment of the authentication unit 4 according to the present invention for a radar system 1, the authentication unit 4 contains a calculation unit BE, as shown schematically in FIG. 4. The calculation unit BE is designed to modify the generated random sequence ZS by means of a first algorithm according to a first specified function (f) for generating a modified random sequence ZSM. The calculation unit BE integrated in the authentication unit 4 is also designed to calculate a radar data packet RDP by means of a second algorithm according to a second specified function (g) on the basis of the modified random sequence ZSM. The data calculated and provided with the authentication sequence AS1 can subsequently be transmitted as a radar data packet RDP_{send} from the transmitting unit 2 of the radar system 1 and simultaneously temporarily stored as an internal radar data packet RDPᵢₙₜₑᵣₙₐₗ in a buffer unit ZSPE of the authentication unit 4. In a possible embodiment of the authentication unit 4 according to the present invention for a radar system 1, the calculation unit BE integrated therein is further designed to compare, by means of a third algorithm (h), a radar data packet RDP_{empf} received by the receiving unit 3 of the radar system 1 with the temporarily stored internal radar data packet RDPᵢₙₜₑᵣₙₐₗ in order to determine whether an authentication sequence AS2 contained in the received radar data packet RDP_{empf} has a sufficient similarity to an authentication sequence AS1 contained in the temporarily stored internal radar data packet RDPᵢₙₜₑᵣₙₐₗ.

According to a further aspect, the present invention further provides a radar system 1 as shown schematically as a block diagram in FIG. 2. The radar system 1 comprises a transmitting unit 2 for transmitting a radar signal RS, wherein an authentication sequence AS1 is embedded in the transmitted radar signal RS1. An authentication sequence AS1 adapted to channel properties of a physical transmission channel PHY is embedded into the transmitted radar signal (RS1).

In one possible embodiment of the method according to the present invention, the channel properties of the physical transmission channel PHY are measured regularly or as a result of a detected event. The authentication sequence AS1 is then adapted to the currently measured channel properties of the physical transmission channel PHY. As a result, the recognizability of the embedded authentication sequence AS in the received radar signal RS2 is further increased.

The radar system 1 further comprises a receiving unit 3 for receiving a radar signal RS2 as shown in FIG. 2. The radar system 1 further comprises an authentication unit 4 that is designed to accept the radar signal RS2 received by the receiving unit 3 of the radar system 1 as valid if an authentication sequence AS2 contained in the received radar signal RS2 has a sufficient similarity to the authentication sequence AS1 embedded in the radar signal RS1 transmitted by the transmitting unit 2 of the radar system 1. In one possible embodiment of the radar system 1 according to the present invention, the received radar signal RS2 accepted as valid is further processed by a signal processing unit 5 of the radar system 1 for detecting an environment of the radar system 1. The transmitting unit 2 and the receiving unit 3 can be integrated in a transceiver 6, as shown schematically in FIG. 4. The transceiver 6 is connected to at least one antenna 7 of the radar system 1 for transmitting and receiving radar signals.

In one possible embodiment of the radar system 1 according to the present invention, the radar system 1 comprises a monostatic radar system, as shown schematically in FIG. 1 to FIG. 4. In a further possible alternative embodiment of the radar system 1 according to the present invention, the radar system 1 comprises a bistatic radar system in which the transmitting unit 2 is located spatially remote from the receiving unit 3.

An authentication component or an authentication unit 4 can be integrated into an existing radar system 1. For each new radar data packet RDP_{send} that is to be transmitted, the built-in authentication unit 4 adds at least one authentication sequence AS1 to the particular radar data packet RDP.

This is achieved by the following steps for transmitting the next radar data packet RDP_{send}:

The authentication unit 4 receives the next random number sequence ZS in the correct length by calling the RNG algorithm.

The calculation unit BE of the authentication unit 4 calculates ZSM=f(ZS).

Subsequently, the calculation unit BE of the authentication unit 4 calculates RDP_{send}=g(ZSM).

The authentication unit 4 outputs RDP_{send} as a radar data packet to be sent, to the transmitting unit 2.

During sensing, the following steps are performed upon reception of a radar data packet RDP (radar frame):

For the received radar signal RS2 or the received radar data packet RDP_{receive}, the third algorithm h (RDP_{receive}, RDPᵢₙₜₑᵣₙₐₗ) is executed for the radar data packet RDPᵢₙₜₑᵣₙₐₗ currently temporarily stored in the buffer unit ZSPE.

According to the indexed similarity as output of the third algorithm h, the authentication component 4 makes a decision about the acceptance or non-acceptance of this current detection. Detection can be performed based on a configured security level. Multiple security levels could be supported to meet different applications with different security requirements.

The individual components are explained in more detail below.

The additional functionality/component “authenticator” is added to the radar system 1, which authenticator adapts and/or creates radar data packets RDP as explained below, forwards them to the subsequent component for transmission and receives the received data, authenticates them and forwards authenticated data to a further component.

This functionality/component “authenticator” can be implemented in hardware or software or a mixture of both. The component can also be integrated as a logical component into other existing radar components, for example those for signal processing.

If, according to the radar technology used, a mentioned individual function/component such as a suitable buffer unit as described below is already present, the presented functionality/component “authenticator” also comprises a possible embodiment in which it is used.

The additional functionality RNG, which is capable of generating cryptographically secure pseudorandom sequences or cryptographically secure random sequences ZS as output, is preferably added to the radar system 1. The output of the random number generator RNG is referred to below as the random sequence ZS. This functionality, which can also be referred to as a random number generator RNG, can be added either in hardware or in software. The input of the random number generator RNG is either an entropy source or a seed, i.e., a random number sequence like a counter that is incremented by the caller with each call and, depending on the implementation, also a size for the output length. Optionally, additional data can also be used as input, which can be particularly interesting for ICAS systems.

Furthermore, a functional logic f or an algorithm f is preferably added to the radar system 1, which functional logic/algorithm receives as input a cryptographically secure pseudorandom sequence or random sequence ZS and converts it into a new output ZSM (modified random sequence), which, for example, is more advantageous for the autocorrelation of the received signal with the expected signal on the transmission medium.

This functionality can also be implemented in hardware or software. The input of the function f can contain additional arguments besides the random sequence ZS. For example, additional components of the provided radar data packet RDP or configuration parameters could be used as input in order to adapt the output according to the current radar data packet or other environment variables. If the algorithm f is not used because it is not considered necessary due to the radar technology, this component can be omitted. This is functionally identical to defining the function f as an identity function x=f(x), which returns its input identically as output. For the further description, the existence of the function f is therefore assumed, and this automatically includes the case that it is not used or does not exist. In one possible implementation, the function f can also call the random number generator function RNG as a subfunction. In one possible embodiment, the function f can also already assemble the radar data packet RDP and output it as output. In this case, the function g would no longer be needed as a separate function.

For each transmitted radar data packet RDP_{send}, also referred to as a frame in the terminology, a newly generated part of the cryptographically secure pseudorandom sequence or random sequence ZS is generated as the output of RNG, and this is translated into a new sequence ZSM with the aid of the function or algorithm f. ZS=RNG(_), ZSM=f(ZS) are thus calculated.

In one possible embodiment, this ZSM value is then added to each RDP_{send} that is transmitted. This means that the function g, which assembles this radar data packet RDP_{send}, is provided with the calculated value ZSM as at least one of its inputs, and the function g then outputs the radar data packet RDP_{send}. The format of the radar data packet RDP_{send} is appropriately selected in order to contain the sequence ZSM. However, the method according to the present invention does not require a fixed data format for the transmitted radar data packet RDP_{send}, as long as the sequence ZSM, either in its entirety or divided into a plurality of subsequences, is contained in the transmitted and temporarily stored radar data packet RDPᵢₙₜₑᵣₙₐₗ.

For the duration of the period in which reflections of the current radar data packet RDP, which contains the modified random sequence ZSM as the authentication sequence AS2, are expected and recognized by the receiving unit 3 of the radar system 1 (with the aim of environmental detection by means of this radar data packet RDP), the value ZSM is temporarily stored by the radar system 1 in the buffer unit ZSPE as the expected authentication sequence AS1. The period can be set in one possible embodiment.

Upon reception of the radar signal RS2 in the current measurement iteration, the received radar signal RS2, or the radar data packet RDP_{receive} obtained therefrom, is compared with the expected and temporarily stored radar data packet RDPᵢₙₜₑᵣₙₐₗ. This is done by the calculation unit BE with the aid of the third algorithm h, which receives the currently received radar data packet RDP_{receive} and the currently temporarily stored radar data packet RDPᵢₙₜₑᵣₙₐₗ as at least two of its inputs and outputs a determined similarity between the two in order to decide on the acceptance or non-acceptance of the received radar data packet RDP_{receive}.

Here, in particular, the received sequence AS2 contained in the received radar data packet RDP_{receive} is also compared with the locally temporarily stored sequence AS1. This can be done, for example, by a correlation algorithm that correlates the expected sequence with the received sequence and thus determines the similarity. The required similarity or correlation threshold for recognizing the radar data packet RDP_{receive} as authentic can be configured depending on the radar technology, the desired security level and the application case.

In contrast to previous non-authenticated variants, the received radar data packet RDP_{receive} is now accepted as valid and further processed only if the received sequence AS2 contained in the received radar data packet RDP_{receive} is sufficiently similar to the expected sequence AS1, as described above. If the two values deviate too much from one another according to the parameters specified in the configuration, the received radar data packet RDP_{receive} is not accepted as valid and is not used or evaluated for the further detection steps.

In one possible implementation of the method according to the present invention, the received radar data packet RDP_{receive} that is not accepted as valid is discarded. In one possible alternative implementation of the method according to the present invention, the received radar data packet RDP_{receive} that is not accepted as valid is not discarded; rather, it is evaluated for detecting and analyzing a possible attack. The number of consecutively discarded radar data packets can also be counted in order, for example, to trigger a warning or another response of the radar system 1 if a threshold value is exceeded.

As an alternative to the embodiment described above, an RNG functionality for generating the sequences used as authentication sequences can also be implemented with a different logic. For example, an algorithm can be used that uses a message authentication code (MAC). From a security perspective, such a function would also be suitable, but there is no tolerance for transmission errors (bit errors) and error-correcting codes, for example, must be added separately. Implementation by means of random sequences or pseudorandom sequences is therefore usually more efficient, in particular if no user data are transmitted and transmission errors are to be expected. However, if a sending method is used that compensates for bit errors or for which transmission errors occur sufficiently rarely, a pseudorandom sequence based on MACs or the reuse of encrypted data can represent a useful implementation of the method according to the present invention.

A pseudorandom number generator PRNG can be initialized, upon start-up of the radar system 1, using the output of a slower RNG. Depending on the instantiation of the PRNG for generating an authentication sequence AS, a secret cryptographic key can also be used as part of the input. However, in contrast to conventional application cases, the latter is not absolutely necessary in the scenario considered here, so that the radar system can be simplified here.

The procedure for creating and subsequently receiving a radar data packet RDP is preferably repeated for each newly transmitted radar data packet RDP_{send} or with each measurement cycle. For each transmitted radar data packet RDP_{send}, a new value ZSM is preferably generated and used. Otherwise, an attacker could send a previously used and intercepted radar data packet RDP back to the radar system 1 as a response for subsequent measurement cycles (replay attack).

Depending on the instantiation used, it may be necessary to update a state for the RNG functionality for each call and to store and keep it available between calls. For example, a pseudorandom number generator PRNG requires a seed that specifies the beginning of the random sequence, since the pseudorandom number generator PRNG always outputs the same pseudorandom number for the same seed. Accordingly, depending on the instantiation of the components, additional data processing steps or temporarily or permanently stored data are provided if applicable.

FIG. 3 schematically shows the functioning of a radar system 1, which transmits correspondingly authenticated radar data packets RDP_{send} as the radar signal RS1 and, after reflection by an object OBJ located in the environment of the radar system 1, receives the transmitted radar data packet again after reflection as the radar signal RS2. The transmitted radar signal RS1 can propagate in a medium, for example in air or water, and is reflected by an object OBJ located in the medium, for example the body of a vehicle.

FIG. 4 shows an exemplary representation in which an authentication component 4 implements the above-described procedure according to the present invention in that the “authenticator” 4 uses subcomponents in order to authenticate the radar data. The input to the “authenticator” can comprise control signals CTRL because, depending on the instantiation, the authenticator 4 or subsequent components can completely generate the radar data packet RDP to be transmitted so that only a control of the component 4 such as a start or a configuration is required. Alternatively, a radar data packet RDP can be passed, which is modified by the “authenticator” 4 by adding the value ZSM. The latter may be the case when using an ICAS system that already provides a pseudorandom sequence, for example through an encrypted bit sequence of data that is to be transmitted at the same time. In this case, the provision of the RNG subcomponent is, if applicable, not required, and, if applicable, this input could be further processed instead.

The method according to the present invention can be used for both stand-alone radar systems and ICAS radar systems. In the event that an ICAS system carries out a dedicated sensing step, a system like the one described above can be used. In the event that data are to be transmitted for communication purposes at the same time, these data can, if necessary, be suitably adapted and then transmitted instead of a dedicated authentication sequence, which is generated solely by the authentication component 4.

A possible extension or alternative instantiation is the use of the authentication component 4 in a bistatic radar. It should be noted here that for use, the sender 2 and the receiver 3 require a secure channel for data exchange so that either the current authentication sequences AS themselves are always available to both the sender 2 and the receiver 3 in a timely manner, or a prior synchronization ensures that the sender 2 and the receiver 3 in each case use matching authentication sequences AS. The latter synchronization must, if applicable, be repeated regularly (for example, upon each restart of the radar system 1).

The method according to the present invention can be used for all radar types that allow the embedding of an authentication sequence AS. These include, for example, digital radars such as OFDM radars or pulse-based radars. The method according to the present invention can also be integrated into the 6G standard.

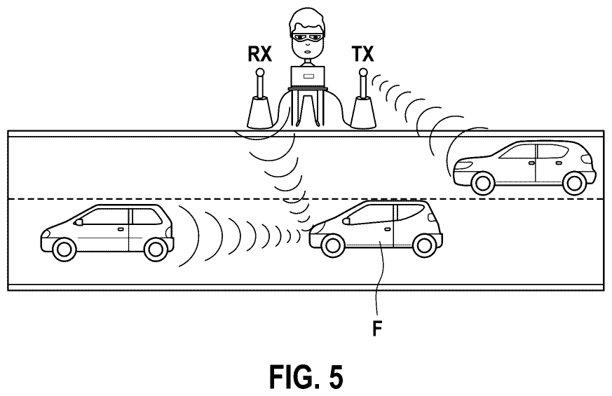

The method according to the present invention can prevent various attacks directed at a road user. FIG. 5 shows an exemplary attack scenario (spoofing). Even though the fake signals transmitted by an attacker (so-called spoofing in security terminology) are a main motivation for the adaptations according to the present invention for a radar system, these adaptations can potentially also be useful in other attack scenarios. Likewise, the presented method can reduce interference as a side effect.

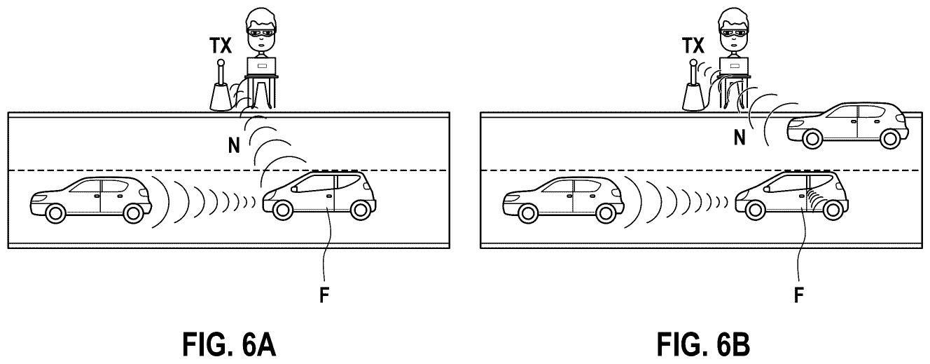

For example, if an attacker, as shown in FIG. 6A, 6B, attempts to deliberately block a conventional radar system by transmitting noise signals (so-called jamming in technical terminology) so that the conventional radar system can no longer perform meaningful detection, the affected radar system is useless for environmental perception in this case. This is particularly dangerous if the radar system is used as an early warning system, for example for collision recognition in vehicles, and automatically triggers emergency braking, for example, or if the radar system is used for another automated driver assistance function that does not correctly or promptly recognize the failure or blockage of the radar system.

FIG. 6A, 6B show two different types of attacks as a result of jamming. FIG. 6A shows so-called forward jamming, in which an adaptive driving distance control of a vehicle F is disturbed by means of a noise signal N (noise). FIG. 6B shows so-called blind spot jamming, in which the detection of another vehicle in a blind spot of the vehicle F is prevented.

The method according to the present invention adds authentication information to the radar signals RS used, with the intention that an attacker is no longer able to respond with appropriate radar signals. An attacker can send back the appropriate sequence only if he has received the radar signal RS1 transmitted by the radar system 1 according to the present invention and it has potentially already been reflected back by its physical surface anyway.

A spoofing attack (as shown in FIG. 5), i.e., the transmission of a fake radar signal, is prevented by the method according to the present invention since an attacker cannot anticipate the authentication information and thus cannot respond faster than the reflected signal. The method according to the present invention thus prevents the spoofing attack shown in FIG. 5 from being successful or having adverse consequences. The importance of preventing such an attack depends on the intended use of the radar system in question and on whether recognition of an attack and subsequent response to it is already provided for and sufficient for the application case.

A jamming attack (as shown in FIG. 6A, 6B), i.e., a blocking of the radar signal RS, is prevented depending on the underlying radar technology used. If the radar system can filter other signals such as noise signals and/or simultaneously recognize the signals containing the authentication information, a jamming attack can be prevented depending on the effectiveness of this distinction. The authentication information can be advantageous for this distinction since the attacker cannot embed it in advance. If a radar system is completely blocked by a high-energy signal and can no longer distinguish between signals based on the authentication information, jamming is still possible. The proposed method can, depending on the application case, also facilitate the detection of a jamming attack by noticing, for example, that no correctly authenticated radar data packets have been received for an excessively long time, and triggering a suitable response.

FIG. 5, 6A, 6B show exemplary attack scenarios. It is possible to use the method according to the present invention in other scenarios in which a radar system is used. These include, for example, radar systems for detecting a vehicle interior or radar systems for other application areas.

Although the present invention has been completely described above with reference to preferred exemplary embodiments, it is not limited thereto, but can be modified in many ways.

What is claimed is:

1. A method for optimized detection of an environment of a radar system, comprising the following steps:
transmitting a radar signal by a transmitting unit of the radar system, wherein an authentication sequence adapted to channel properties of a physical transmission channel is embedded into the transmitted radar signal;
receiving a radar signal by a receiving unit of the radar system via the physical transmission channel; and
accepting the radar signal received by the receiving unit of the radar system as valid when an authentication sequence contained in the received radar signal has a sufficient similarity to the authentication sequence embedded in the transmitted radar signal and adapted to the channel properties of the physical transmission channel.

2. The method for detecting an environment of a radar system according to claim 1, wherein the authentication sequence embedded in the transmitted radar signal is generated based on a provided random sequence.

3. The method for detecting an environment of a radar system according to claim 2, wherein the random sequence includes a random bit sequence that is generated by a random number generator of the radar system.

4. The method for detecting an environment of a radar system according to claim 2, wherein the random sequence is generated by an encryption unit of the radar system according to an encryption function.

5. The method for detecting an environment of a radar system according to claim 2, wherein the generated random sequence is modified using of a first algorithm according to a first specified function for generating a modified random sequence.

6. The method for detecting an environment of a radar system according to claim 5, wherein the generated random sequence is modified, for generating the modified random sequence, by interleaving the random sequence with further provided bits, which adapt signal properties of the authentication sequence that is embedded into the radar signal transmitted by the transmitting unit, in such a way that the authentication sequence contained within the radar signal received by the receiving unit via the physical transmission channel is more clearly recognizable.

7. The method for detecting an environment of a radar system according to claim 6, wherein the provided bits with which the random sequence is interleaved include a firmly specified sequence of bits or are selected according to bit sequences within the random sequence.

8. The method for detecting an environment of a radar system according to claim 7, wherein the random sequence includes a random bit sequence, which is divided into a plurality of groups of random bits, wherein provided bits are inserted between two consecutive groups of random bits in each case, which provided bits adapt the signal properties of the authentication sequence that is embedded into the radar signal transmitted by the transmitting unit, in such a way that the authentication sequence contained within the radar signal received by the receiving unit of the radar system via the physical transmission channel is more clearly recognizable.

9. The method for detecting an environment of a radar system according to claim 8, wherein the groups of random bits within the random bit sequence of the random sequence each include a certain number of random bits.

10. The method for detecting an environment of a radar system according to claim 9, wherein the bits inserted between two consecutive groups of random bits of the random bit sequence of the random sequence include at least one code bit sequence of a code set including different code bit sequences, which are selected according to a preceding and/or a subsequent group of random bits of the random sequence.

11. The method for detecting an environment of a radar system according to claim 10, wherein the bits of the at least one code bit sequence inserted between two consecutive groups of random bits of the random bit sequence of the random sequence, from the code set including different code bit sequences are selected: (i) according to channel properties of the physical transmission channel and/or (ii) according to the preceding and/or subsequent group of random bits of the random sequence.

12. The method for detecting an environment of a radar system according to claim 10, wherein the random bits of the preceding group of random bits and the random bits of the subsequent group of random bits each form an index, which is used for selecting the inserted code bit sequence.

13. The method for detecting an environment of a radar system according to claim 5, wherein a radar data packet is calculated using a second algorithm according to a second specified function based on the modified random sequence.

14. The method for detecting an environment of a radar system according to claim 13, wherein the calculated radar data packet is transmitted by the transmitting unit of the radar system and is temporarily stored as an internal radar data packet in a buffer unit of the radar system.

15. The method for detecting an environment of a radar system according to claim 14, wherein a radar data packet received by the receiving unit of the radar system is compared using a third algorithm with the internal radar data packet temporarily stored in the buffer unit, to determine whether an authentication sequence contained in the received radar data packet has a sufficient similarity to an authentication sequence contained in the temporarily stored internal radar data packet.

16. The method for detecting an environment of a radar system according to claim 15, wherein the radar data packet received by the receiving unit of the radar system is accepted as valid when the authentication sequence contained in the received radar data packet has a sufficient similarity to the authentication sequence contained in the temporarily stored internal radar data packet).

17. An authentication unit for a radar system configured to accept a radar signal received by a receiving unit of the radar system via a physical transmission channel as valid when an authentication sequence contained in the received radar signal has a sufficient similarity to an authentication sequence that is embedded in a radar signal transmitted by a transmitting unit of the radar system and that is adapted to channel properties of the physical transmission channel.

18. The authentication unit for a radar system according to claim 17, wherein the authentication unit includes: (i) a random number generator that is configured to generate a random bit sequence as a random sequence, and/or (ii) an encryption unit that is configured to generate a random sequence according to an encryption function, wherein the authentication sequence embedded in the transmitted radar signal is generated based on the generated random sequence.

19. The authentication unit for a radar system according to claim 18, wherein the generated random sequence is modified, for generating a modified random sequence, by interleaving the random sequence with further provided bits, which adapt signal properties of the authentication sequence that is embedded into the radar signal transmitted by the transmitting unit, in such a way that the authentication sequence contained within the radar signal received by the receiving unit via the physical transmission channel is more clearly recognizable.

20. The authentication unit for a radar system according to claim 18, wherein the authentication unit includes a calculation unit that is configured to modify the generated random sequence using a first algorithm according to a first specified function for generating the modified random sequence, to calculate a radar data packet using a second algorithm according to a second specified function based on the modified random sequence, wherein the calculated radar data packet is transmitted by the transmitting unit of the radar system and is temporarily stored as an internal radar data packet in a buffer unit of the authentication unit, and wherein the calculation unit is configured to compare, using a third algorithm, a radar data packet received by the receiving unit of the radar system with the temporarily stored internal radar data packet in order to determine whether an authentication sequence contained in the received radar data packet has a sufficient similarity to an authentication sequence contained in the temporarily stored internal radar data packet.

21. A radar system, comprising:
a transmitting unit configured to transmit a radar signal, wherein an authentication sequence is embedded in the transmitted radar signal, wherein the authentication sequence is adapted to channel properties of a physical transmission channel;
a receiving unit configured to receive a radar signal via the physical transmission channel; and
an authentication unit configured to accept a radar signal received by the receiving unit of the radar system via the physical transmission channel as valid if an authentication sequence contained in the received radar signal has a sufficient similarity to the authentication sequence that is embedded in the radar signal transmitted by the transmitting unit of the radar system and that is adapted to the channel properties of the physical transmission channel.

22. The radar system according to claim 21, wherein the received radar signal accepted as valid by the authentication unit is further processed by a signal processing unit of the radar system for detecting an environment of the radar system.

23. The radar system according to claim 21, wherein the radar system includes a monostatic or a bistatic radar system.
